(19) United States
(12) Patent Application Publication
(10) Pub. No.: US 2017/0180616 A1
(43) Pub. Date: Jun. 22, 2017

(54) LIGHT INDICATION DEVICE FOR FACE RECOGNITION SYSTEMS AND METHOD FOR USING SAME

(71) Applicant: FST21 Ltd, Rishon Lezion (IL)

(72) Inventors: Ofir FRIEDMAN, Rishon Le-Zion (IL); Shanar BELKIN, Kibbutz Brur Chayil (IL)

(21) Appl. No.: 15/129,840

(22) PCT Filed: Apr. 1, 2015
(86) PCT No.: PCT/IL2015/050356

§ 371 Date: Sep. 28, 2016

Related U.S. Application Data
(60) Provisional application No. 61/973,904, filed on Apr. 2, 2014.

(51) Int. Cl. H04N 5/225; G03B 17/18; G03B 15/05; H04N 5/232; G06K 9/00

(52) U.S. Cl. CPC H04N 5/2256; H04N 5/23219; G06K 9/00288; G06K 9/00268; G03B 15/05; G03B 17/18; G03B 2215/0575; H04N 5/23222

(57) ABSTRACT

A light indication device and a light indication method for a face recognition system are disclosed. The light indicator may be adapted to attract the attention of a person to a camera and provide the person feedback and indications as to the pose of his or hers face in a captured image and how to correct it, as well as indications regarding the progress of the face recognition process. The light indication device may comprise a housing having an central aperture adapted to accommodate a camera, a processor, a memory, a plurality of light emitting elements and a sensor to sense when a person is in vicinity to the light indication device. A method for using the light indication device is also provided.

### BACKGROUND OF THE INVENTION

Face recognition systems that are based on image analysis require a person to pose in front of a camera to provide face images to the system. In many cases, images obtained by such a face recognition system are insufficient in order to extract the required data from the captured image, due to improper pose of the person in front of the camera. However, current face recognition systems provide no feedback to the person regarding the face recognition process and how to correct his or her pose in front of the camera. Therefore, the recognition process may fail, may take a long time and may be inefficient in terms of computing resources usage.

### SUMMARY OF THE INVENTION

Embodiments of the present invention provide a light indication device and a light indication method for a face recognition system. The light indicator according to embodiments of the present invention may be adapted to attract the attention of a person to a camera and provide the person feedback and indications as to the pose of his or hers face in a captured image and how to correct it, as well as indications regarding the progress of the face recognition process. A method for using the light indication device is also provided.

According to some embodiments of the present invention a light indicator for a face recognition system, may comprise a housing having a central aperture configured to accommodate an image input device, such as a camera. The light indicator may further comprise a processor, a memory to store captured images and image analysis tools, a plurality of light emitting elements, such as Light Emitting Diodes (LEDs) and a power source, such as a battery. The plurality of light emitting elements may be arranged, according to one embodiment, along a circumference of the central aperture in the housing.

According to some embodiments, the processor is configured to activate one or more of the plurality of light emitting elements to create a light sequence. The light sequence may be determined based on input received from the image input device of the face recognition system.

According to some embodiments, the processor may be configured to initiate the operation of the image input device to capture images of a face of a person, and to analyze the captured images, by operating image analysis tools stored in the memory.

In yet another embodiment, the light indicator may further comprise a white light source.

The processor according to some embodiments may be configured to extract information regarding a pose of a face in an image captured by the image input device.

The light indicator according to some embodiments may further comprise a sensor configured to determine a person is in vicinity of the light indicator. The sensor may be one or more of a list consisting: a proximity sensor, a motion sensor and a volume sensor.

According to some embodiments, a method of providing a light indication for a face recognition system may comprising: identifying a presence of a person in a vicinity of a camera of a face recognition system; capturing one or more images by the camera of the face recognition system; determining, by a processor, that the one or more captured images comprise an image of a face; determine, by the processor, the pose of the face in the one or more captured images; and initiating a light sequence indicative of a required change of the face pose.

According to some embodiments the method may further comprise initiating an attention attracting light sequence to attract attention to the camera prior to the capturing of the one or more images.

According to some embodiments the method may further comprise initiating a another light sequence to indicate that the required change of face pose has been properly performed. According to some embodiments, when the determined pose of the face is sufficient for face recognition, the method may further comprise determining the identity of the person in the vicinity of the face recognition system, and provide a positive identification indication or a non-identification indication according to the results of the recognition process.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a front view illustration of a light indicator according to some embodiments of the present invention;

FIG. 2 is an isometric view of the embodiment illustrated in FIG. 1;

FIG. 3 is a side view illustration of a light indicator according to embodiments of the present invention;

FIG. 4 is a block diagram of the components of a light indicator according to embodiments of the present invention; and

FIG. 5 is a flowchart of a method for using a light indicator according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time or overlapping points in time. As known in the art, an execution of an executable code segment such as a function, task, sub-task or program may be referred to as execution of the function, program or other component.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

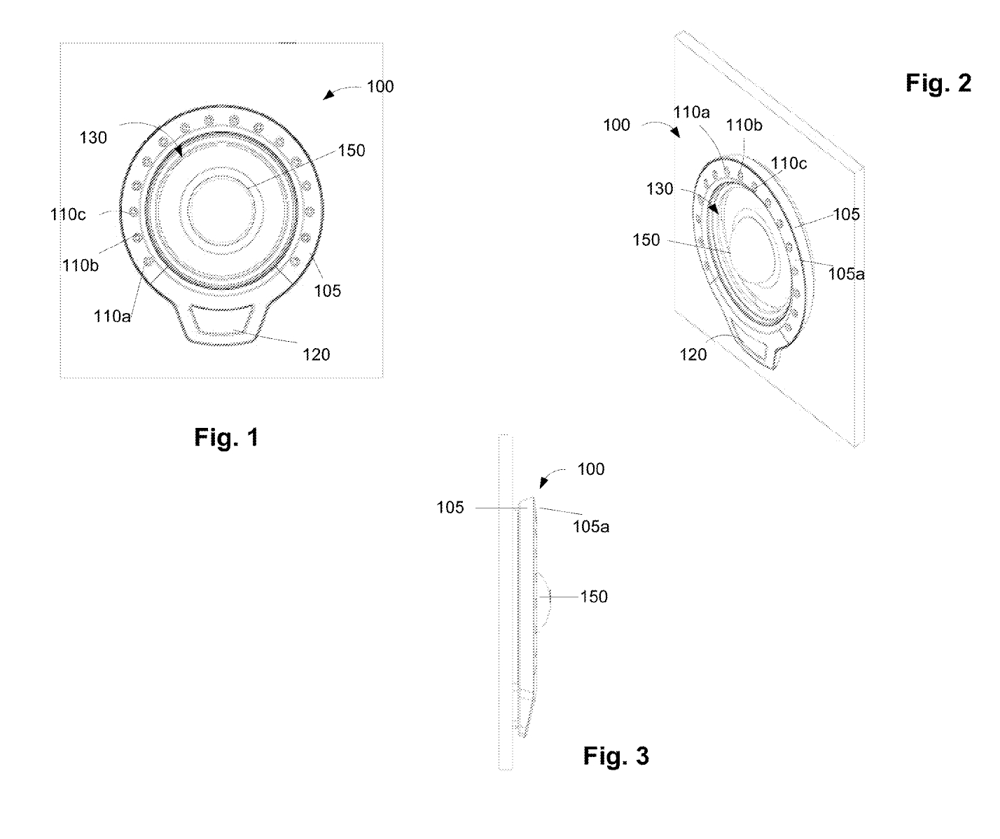

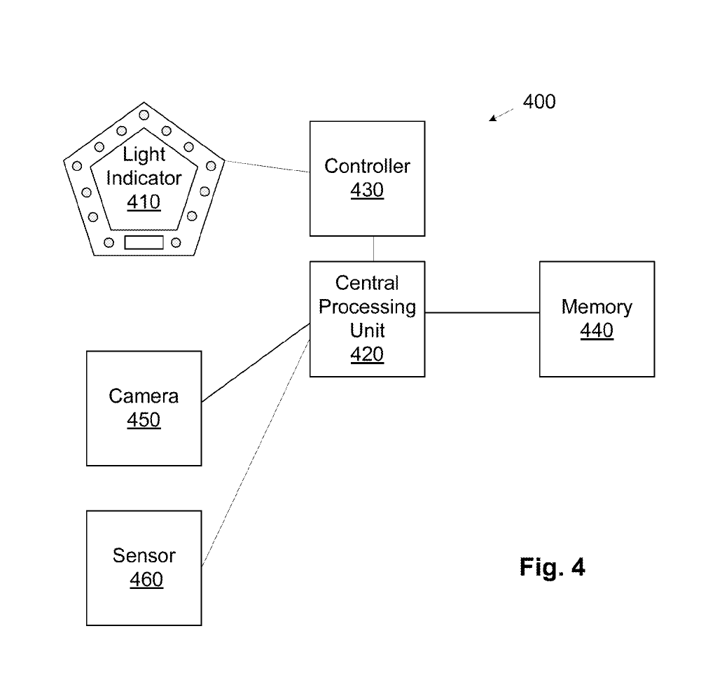

Reference is now made to FIGS. 1, 2 and 3 which are schematic illustrations of light indicator 100 according to some embodiments of the present invention. Light indicator 100 may comprise a housing 105 to accommodate a Printed Circuit Board (PCB) (not shown). A plurality of components may be attached to the PCB. According to one embodiment of the present invention, a plurality of light emitting elements, such as Light Emitting Diodes (LED) may be attached to the PCB. According to some embodiments, in addition to the plurality of LEDs, a processor such as Central Processing Unit (CPU) (420 in FIG. 4), may be connected to the PCB.

According to some embodiments, housing 105 may comprise a processor (420 in FIG. 4), connected to a controller (430 in FIG. 4) which is in active communication with a Programmable Logic Device, such as a Complex Programmable Logic Device (CPLD). Housing 105 may further comprise a power source (not shown). It should be appreciated that controller (430 in FIG. 4) may be an integral part of processor (420 in FIG. 4) or that processor (420 in FIG. 4) may serve also as a controller.

The CPLD may activate a plurality of LEDs 110a, 110b, 110c or other light emitting elements. It would be appreciated by those skilled in the art that the CPLD may activate LEDs 110a, 110b, 110c according to commands received from controller (430 in FIG. 4), which may be activated by CPU (420 in FIG. 4) in different lighting sequences or modes in accordance with the desired feedback to the person in the vicinity of camera 150. It should be appreciated that according to some embodiments, controller (420 in FIG. 4) and CPLD may be a single integrated component. It should be further appreciated that according to some embodiments, CPLD may not be required and controller (420 in FIG. 4) may initiate and control the operation of light emitting elements, such as LEDs 110a, 110b, 110c. It should be also appreciated by those skilled in the art that processor (430 in FIG. 4) may serve as a controller.

Light emitting elements, such as LEDs 110a, 110b, 110c may emit light in multiple colors. According to some embodiments of the present invention, a white light source 120 may be also attached to the PCB in housing 105. White light source 120 may be for focusing of camera 150 as well as for providing feedback and indications to the person to be identified. It would be appreciated that housing 105 may have a cover 105a that has transparent portions located in front of light emitting elements, such as LEDs 110a, 110b, 110c and white light source 120. According to alternative embodiments, cover 105a of housing 105 may have holes or apertures to allow light from light emitting elements 110a, 110b, 110c and white light source 120, to be seen from the outside of housing 105.

According to some embodiments of the present invention, housing 105 may be shaped substantially as a ring, as seen in FIGS. 1, 2 and 3. The ring-like shape may allow placing a camera 150 in the center of light indicator 100 or behind a central aperture 130 in housing 105 so that the field of view of camera 150 is not limited by housing 105. It would be appreciated that other shapes and designs of light indicator 100 may be used, such as a rectangular housing, a triangular housing, a hexagonal housing and the like, as long as housing 105 has central aperture 130 to accommodate camera 150.

According to one embodiments of the present invention, light emitting elements 110a, 110b, 110c and 120 may be arranged along a circumference of central aperture 130. Light emitting elements 110a, 110b, 110c and 120 may be arranged in a single line along the circumference of central aperture 130 or may be arranged in a plurality of lines, such as a plurality of circular lines with a common center.

Reference is now made to FIG. 4 which is a block diagram of components of light indicator system 400 according to embodiments of the present invention. System 400 may comprise a light indicator 410, a processor, such as CPU 420, a controller 430, a memory 440, an image input device, such as camera 450, and a sensor 460.

Sensor 460 may be a motion sensor, a volume sensor, a proximity sensor, or any other sensor that may indicate that a person is in the vicinity thereof. It should be appreciated that sensor 460 may be placed in proximity to camera 450. Thus, when a person is in the vicinity of sensor 460 and triggers sensor 460 he or she is also near camera 450.

According to some embodiments of the present invention, CPU 420 may control the operation of light indictor 410 via controller 430, based on input received from sensor 460, and from image input device, such as camera 450.

For example, when CPU 420 receives an indication from sensor 460 that a person is in the vicinity of sensor 460 and thus of camera 450, CPU 420 may send a command to controller 430 to start a first lighting sequence, which is intended to draw the person's attention to camera 450. Controller 430 may then turn LEDs in light indicator 410 on and off. Alternatively system 400 may execute a motion detecting algorithm that may provide indication of an object in a field of view (FOV) of camera 450 and further/based on contour and size evaluation may provide a signal that a person is in the vicinity of camera 450.

CPU 420 may then initiate the operation of camera 450 to receive images of the person. When images are received from camera 450, CPU 420 may analyze the images, by operating image analysis tools stored in memory 440, to determine whether a face may be identified in the obtained image or images.

If a face is not identified in the obtained image, a command to controller 430 may be sent, to restart the lighting sequence or to start a different sequence in order to attract the person's attention to camera 450. If a face is identified, the image may be analyzed to determine whether the pose of the face is sufficient in order to identify the person in the image or images by a face recognition tool stored in memory 440.

When the pose of the face in one or more images is sufficient in order to identify the person in an image, processor 420 may check whether enough information has been obtained, that is whether there is a sufficient number of frames or images including the face of the person in order to identify the person in the image, and if there is sufficient information, an identification process may be conducted by comparing one or more face images of the person with pre-obtained images stored in memory 440. According to some embodiments, during the identification process an indication of the identification process progress may be provided by illuminating consecutive LEDs as the process progresses. For example, when the process begins, a first LED may be illuminated (such as LED 110a in FIG. 1), then a second LED may be illuminated, (such as LED 110b in FIG. 1) so that two LEDs are illuminated, and so on. According to some embodiments, when the process ends, all LEDs may be illuminated.

According to some embodiments, when the pose of the face in one or more images is improper in order to identify the person in the image, for example when the eyes of the person cannot be identified in the image, processor 420 may instruct controller 430 to initiate a lighting sequence to indicate to the person how to correct the pose of the face. For example, if the face should be tilted upwards, the LEDs on the top of light indicator 410 (e.g. LEDs 110a, 110b and 110c in FIG. 2) may flash in a first color, such as red, until the face of the person is tilted so that the face is in a proper pose. According to some embodiments when the person moves his face to the correct pose, the color of the blinking of flashing LEDs may change, for example to green.

Processor 420 may be configured to carry out all or part of embodiments of the present invention by for example executing code or instructions stored for example in memory 440.

Memory 440 may be or may include, for example, a Random Access Memory (RAM), a read only memory (ROM), a Dynamic RAM (DRAM), a Synchronous DRAM (SD-RAM), a double data rate (DDR) memory chip, a Flash memory, a non-transitory memory or other suitable memory units or storage units.

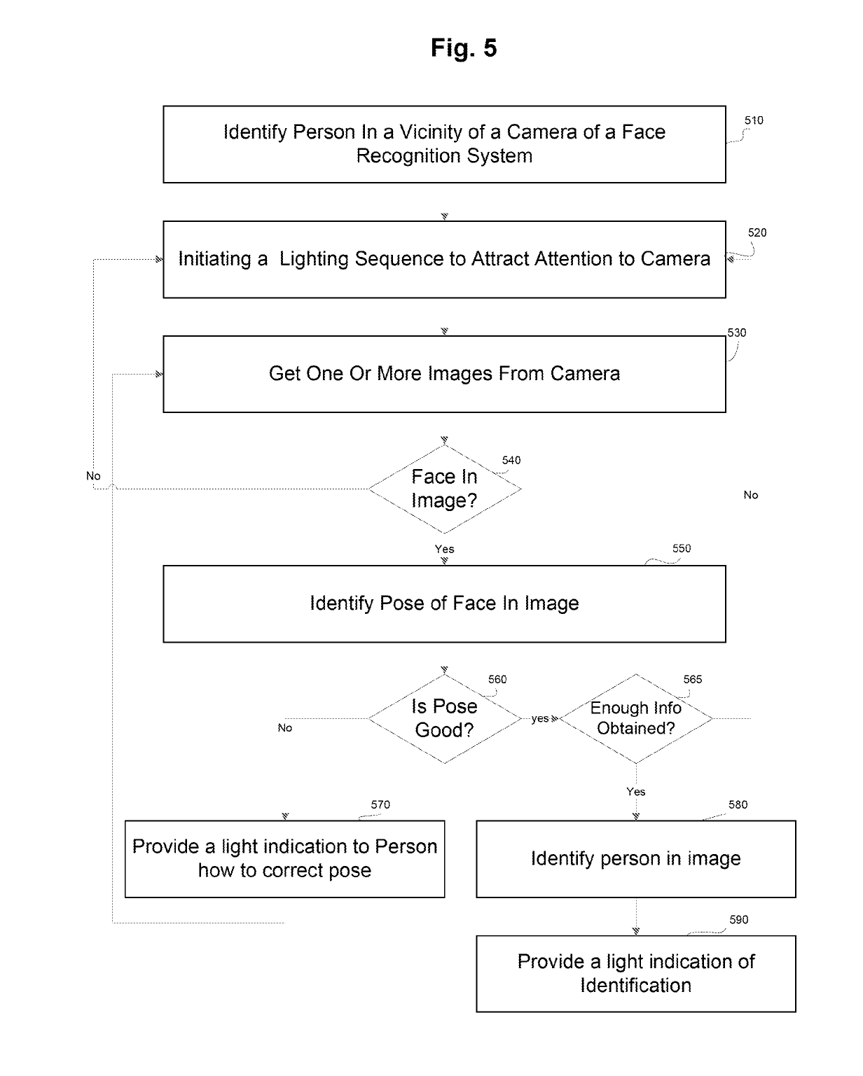

With reference to FIG. 5 a method for using a light indicator in a face recognition system according to embodiments of the present invention is provided. According to some embodiments of the present invention, the method may comprise identifying the presence of a person in the vicinity of a camera or another image input device associated with a face recognition system (block 510). This may be done, for example, by the use of a sensor, such as a motion detector, to identify motion within a predefined distance from the sensor.

When the presence of a person is identified, a processor may instruct a controller to initiate a light indicator in a lighting sequence to attract the attention to the camera (block 520). For example, the attention attraction sequence may be blinking or flashing all light emitting elements, in changing colors.

According to some embodiments, after or simultaneously with initiating the lighting sequence, a camera may start obtaining images (block 530).

The processor may then analyze the obtained image or images to identify whether a face may be identified in the image or images (block 540). If a face cannot be identified in the image(s), the lighting sequence initiated in block 520 may be repeated or a different attention attracting sequence may be started.

When a face may be identified in one or more images, an image analysis tool, stored in a memory, may be used by the processor, in order to identify the pose of the face in the image (block 550).

According to embodiments of the present invention, the processor may then check whether the identified pose of the face in the image(s) is proper for identifying the person in the image(s) (block 560). When the pose is improper for face recognition purposes, the processor may instruct a controller to turn on the light indicator to present a light indication as to how to correct the pose of the face (block 570). For example, if the face should be moved upwards, the light emitting elements at the top of light indicator may blink or flash or be steadily lit, in a first color, such as red, until the pose of the face is corrected. When the pose is corrected, the lighting sequence may be changed and/or the color of the light emitting elements may be changed, e.g. to green.

When the pose of the face is identified to be proper for face recognition purposes (e.g. the pose of the face in the captured image is sufficient in order to recognize the person in the captured image), the processor may check whether sufficient information (e.g. sufficient number of frames or images) have been obtained in order to complete the face recognition process (block 565). When further information is required, the method may return to block 520 and a predefined lighting sequence may be initiated and further images may be obtained (block 530).

When sufficient information has been obtained, a face recognition process may be conducted by comparing images obtained by the camera, with pre-obtained images, stored in a memory (block 580). During the face recognition process, a light indication of the progress of the recognition process may be provided by initiating a lighting sequence that is indicative of the progress.

According to some embodiments, when the face recognition process has been completed, a light indication of the outcome of the process may be provided (block 590). For example, when a positive identification has been archived (e.g. the person in the vicinity of the face recognition system has been recognized), all LEDs may blink in green, while when the person was not identified, all LEDs may blink in red. It should be appreciated that other indications and sequences may be used.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A light indicator for a face recognition system, comprising:
a housing having a central aperture configured to accommodate an image input device;
a processor;
a memory;
a plurality of light emitting elements, and
a power source,
wherein the processor is configured to activate one or more of the plurality of light emitting elements to create a light sequence, wherein the light sequence is determined according to input received from the image input device of the face recognition system.

2. The light indicator according to claim 1 wherein the processor is configured
to initiate the operation of the image input device to capture images of a face of a person; and
to analyze the captured images, by operating image analysis tools stored in the memory.

3. The light indicator according to any one of the preceding claims further comprising a white light source.

4. The light indicator according to claim 2 wherein the processor is configured to extract information regarding a pose of a face in an image captured by the image input device.

5. The light indicator according to any one of the preceding claims further comprising a sensor configured to determine a person is in vicinity of the light indicator.

6. The light indicator according to claim 5 wherein the sensor is one of a list consisting: a proximity sensor, a motion sensor and a volume sensor.

7. The light indicator according to any one of the preceding claims wherein the plurality of light emitting elements are arranged along a circumference of the central aperture in the housing.

8. A method of providing a light indication for a face recognition system, the method comprising:
identifying a presence of a person in a vicinity of a camera of a face recognition system;
capturing one or more images by the camera of the face recognition system;
determining, by a processor, that the one or more captured images comprise an image of a face;
determine, by the processor, the pose of the face in the one or more captured images; and
initiating a first light sequence indicative of a required change of face pose.

9. The method according to claim 8 further comprising initiating an attention attracting light sequence to attract attention to the camera prior to the capturing of the one or more images.

10. The method according to any one of claims 8 and 9 further comprising initiating a second light sequence to indicate that the required change of face pose has been properly performed.

11. The method according to any one of claims 8-10, further comprising when the determined pose of the face is sufficient for face recognition, determining the identity of the person in the vicinity of the face recognition system.

12. The method according to claim 11 further comprising providing a positive identification light indication when the person is identified.
